(19) United States
(12) Patent Application Publication
(10) Pub. No.: US 2016/0374039 A1
(43) Pub. Date: Dec. 22, 2016

(54) SYSTEMS, METHODS, AND DEVICES FOR SYNCHRONIZATION AND RESOURCE ALLOCATION FOR DEVICE-TO-DEVICE COMMUNICATION

(71) Applicant: INTEL CORPORATION, Santa Clara, CA (US)

(72) Inventors: Alexey Khoryaev, Nizhny Novgorod (RU); Mikhail Shilov, Nizhny Novgorod (RU); Sergey Panteleev, Nizhny Novgorod (RU); Debdeep Chatterjee, Mountain View, CA (US)

(73) Assignee: INTEL CORPORATION, Santa Clara, CA (US)

(21) Appl. No.: 15/032,078

(22) PCT Filed: Jan. 30, 2015
(86) PCT No.: PCT/US2015/013789

§ 371 Date: Apr. 26, 2016

Related U.S. Application Data
(60) Provisional application No. 61/933,874, filed on Jan. 31, 2014.

(51) Int. Cl. H04W 56/00

(52) U.S. Cl. CPC H04W 56/0015; H04W 72/048

(57) ABSTRACT

A user equipment (UE) is configured to synchronize with an independent synchronization source (I-SS) based on a first synchronization signal received from the I-SS. The UE is configured to determine whether a received signal strength from the I-SS is below a threshold value. The UE is configured to, in response to determining that the I-SS is below the threshold value, transmit a second synchronization signal propagating synchronization information derived from the I-SS to one or more peer UEs out of range of the I-SS. The second synchronization signal comprises a device-to-device synchronization signal (D2DSS).

### RELATED APPLICATION

This application claims the benefit under 35 U.S.C. §119(e) of U.S. Provisional Application No. 61/933,874, filed Jan. 31, 2014 with a docket number P63801Z, which is hereby incorporated by reference herein in its entirety.

### TECHNICAL FIELD

The present disclosure relates to device-to-device communication and more particularly relates to synchronization and resource allocation for device-to-device communication.

### BRIEF DESCRIPTION OF THE DRAWINGS

FIG. 1A is a schematic diagram illustrating an example of non-overlapping transmission areas.

FIG. 1B is a schematic diagram illustrating an example of partially overlapping transmission areas.

FIG. 1C is a schematic diagram illustrating an example of fully overlapping transmission areas.

FIG. 2A is a schematic diagram illustrating synchronization areas according to a system-level simulation without muting, according to one embodiment.

FIG. 2B is a schematic diagram illustrating synchronization areas according to a system-level simulation with muting, according to one embodiment.

FIG. 3A is a schematic graphical diagram illustrating a number of synchronization sources depending on threshold values, according to one embodiment.

FIG. 3B is another schematic graphical diagram illustrating a number of synchronization sources depending on threshold values, according to one embodiment.

FIG. 4 is a schematic diagram illustrating synchronization areas with different notions of time, according to one embodiment.

FIG. 5A is a schematic graphical diagram illustrating a cumulative distribution function (CDF) of a number of covered receiving user equipments (UEs) per transmitter for three transmitters per sector, according to one embodiment.

FIG. 5B is a schematic graphical diagram illustrating a cumulative distribution function (CDF) of a number of covered receiving UEs per transmitter for nine transmitters per sector, according to one embodiment.

FIG. 6 is a schematic block diagram illustrating components of a wireless communication device, according to one embodiment.

FIG. 7 is a schematic flow chart diagram illustrating a method for hierarchal device-to-device synchronization, according to one embodiment.

FIG. 8 is a schematic flow chart diagram illustrating a method for hierarchal D2D synchronization and resource allocation, according to one embodiment.

FIG. 9 is a schematic flow chart diagram illustrating a method for hierarchal D2D synchronization and resource allocation, according to one embodiment.

FIG. 10 is a schematic flow chart diagram illustrating a method for hierarchal D2D synchronization and resource allocation, according to one embodiment.

FIG. 11 illustrates a diagram of a wireless device (e.g., UE) in accordance with an example.

### DETAILED DESCRIPTION OF PREFERRED EMBODIMENTS

A detailed description of systems and methods consistent with embodiments of the present disclosure is provided below. While several embodiments are described, it should be understood that this disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments may be practiced without some or all of these details. Moreover, for the purpose of clarity, certain technical material that is known in the related art has not been described in detail in order to avoid unnecessarily obscuring the disclosure.

Wireless mobile communication technology uses various standards and protocols to transmit data between a node (e.g., a transmission station or a transceiver node) and a wireless device (e.g., a mobile communication device). Some wireless devices communicate using orthogonal frequency division multiple access (OFDMA) in a downlink (DL) transmission and single carrier frequency division multiple access (SC-FDMA) in an uplink (UL) transmission. Standards and protocols that use orthogonal frequency division multiplexing (OFDM) for signal transmission include the 3rd Generation Partnership Project (3GPP) long term evolution (LTE) Rel. 8, 9, and 10; the Institute of Electrical and Electronics Engineers (IEEE) 802.16 standard (e.g., 802.16e, 802.16m), which is commonly known to industry groups as WiMAX (Worldwide interoperability for Microwave Access); and the IEEE 802.11-2012 standard, which is commonly known to industry groups as Wi-Fi.

In a 3GPP radio access network (RAN) LTE system, the node may be a combination of Evolved Universal Terrestrial Radio Access Network (E-UTRAN) Node Bs (also commonly denoted as evolved Node Bs, enhanced Node Bs, eNodeBs, or eNBs) and Radio Network Controllers (RNCs), which communicate with the wireless device, known as a user equipment (UE). The DL transmission may be a communication from the node (e.g., eNB) to the wireless device (e.g., UE, terminal, wireless communication device, etc.), and the UL transmission may be a communication from the wireless device to the node.

Proximity-based applications and proximity services (ProSe) represent an emerging social-technological trend. Proximity-based communication, which are also referred to herein as device-to-device (D2D) communication, direct communication, or peer-to-peer services or communication, is a powerful technique for increasing network throughput, or communicating in case of damage to network infrastructure, by enabling direct communications between mobile stations rather than using network infrastructure, and has a wide variety of applications. For example, D2D has been proposed for local social networks, content sharing, location-based marketing, service advertisements, public safety networks, mobile-to-mobile applications, and other services. D2D communications are of interest due to their ability to reduce load on a core network or a RAN, increase data rates due to direct and short communication paths, provide public safety communication paths, and provide other functionality. The introduction of a ProSe capability in LTE would allow the 3GPP industry to serve this developing market, and, at the same time, serve the urgent needs of several public safety services. This combined use may enable economy of scale advantages because the resulting system may be used for both public safety and non-public-safety services, where possible.

There are various alternatives to realize such a direct communication path between mobile devices. In one embodiment, the D2D air interface PC5 (i.e., interface for D2D communication) could be realized by some type of short-range technology, such as Bluetooth or Wi-Fi, or by reusing a licensed LTE spectrum, such as a UL spectrum in frequency division duplex (FDD) system and UL subframes in time division duplex (TDD) system.

One common requirement for public safety communication is to support voice over internet protocol (IP) (VoIP) services over large transmission ranges. According to currently agreed D2D evaluation methodology, the receivers that may be interested in reception of the VoIP traffic from the transmitter may be located in up to a 135 decibel (dB) transmission range. Moreover, a large amount of the associated receivers may have low path gain to the transmitter (i.e., are far from the broadcasting transmitter of interest). In a given geographical area, there may be several transmitters that want to transmit VoIP traffic. In order to reach distant receivers each transmitter may need to transmit a VoIP packet in a narrow part of the spectrum (i.e., several physical resource blocks [PRBs]) over multiple subframes in order to accumulate sufficient energy per information bit to reach a 2% packet error rate (PER) at a 135 dB maximum coupling loss.

Analysis by applicants has shown that transmission over two to three PRBs and at least four transmission time intervals (TTIs) may be necessary to achieve the target maximum coupling loss (MCL). However, a number of problems need to be solved when broadcast communication is considered. First, transmitters, if not synchronized, may transmit communications that often collide with each other, which can lead to an asynchronous type of interference degrading performance. Second, transmitters may need to be synchronized and orthogonalized in time and/or frequency in order to avoid co-channel interference. Third, even synchronized transmitters may cause significant interference issues at the receiver side when transmitting simultaneously on orthogonal frequency resources due to unavoidable in-band emissions. The in-band emission effect may significantly degrade performance if several transmitters occupy the same time slot, even if they are using different frequency resources.

A combination of the above problems and their effects may significantly degrade performance of VoIP public safety services in out-of-network coverage scenarios or partial network coverage scenarios, especially taking into account the broadcast nature of D2D operation and no physical layer feedback from receivers.

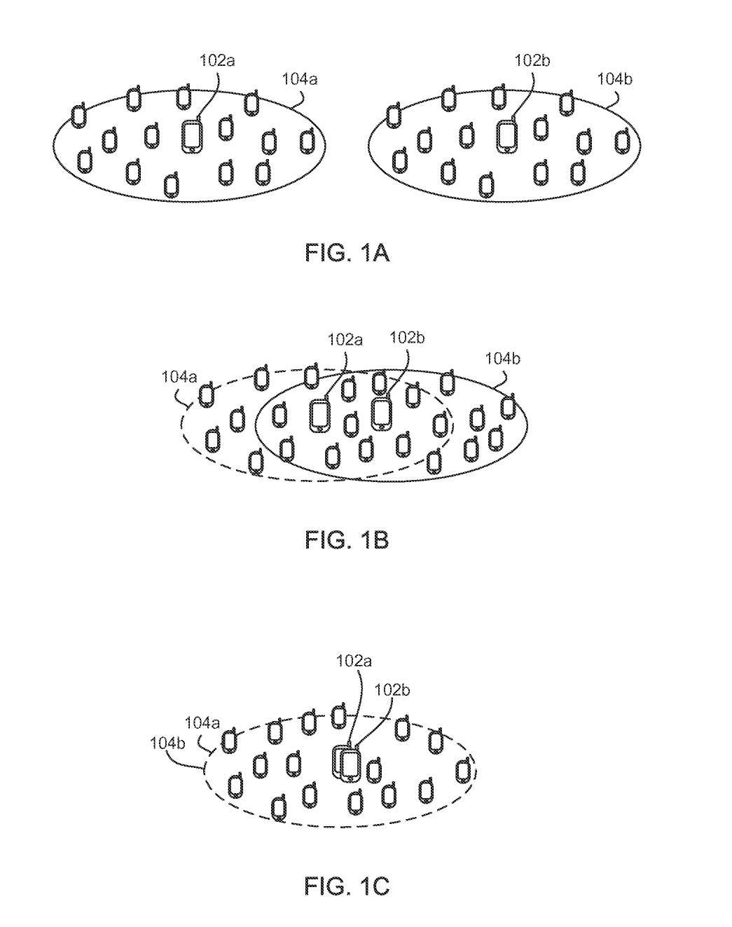

In-band emission can be harmful for broadcast communication when receivers attempt to process signals from multiple transmitters that are transmitting in the same time resource. FIG. 1A, FIG. 1B, and FIG. 1C illustrate different situations for transmitters 102a and 102b that are transmitting within corresponding transmission areas. FIG. 1A shows a non-overlapped situation wherein a first transmitter 102a is transmitting within a first transmission area 104a that does not overlap with a second transmission area 104b corresponding to a second transmitter 102b. FIG. 1B shows the transmitters 102a and 102b transmitting within partially overlapping transmission areas 104a and 104b. FIG. 1C shows the transmitters 102a and 102b having fully overlapped transmission areas 104a and 104b.

The following observations can be made assuming simultaneous transmissions on orthogonal frequency resources. In the case of non-overlapped areas (e.g., FIG. 1A), transmitters have disjoint sets of associated receivers. Receivers can generally successfully receive data from a corresponding transmitter within transmission range. In case of partially overlapped areas (e.g., FIG. 1B), there may be users interested in reception from both transmitters (such as both the first transmitter 102a and the second transmitter 102b) but are able to receive a signal only from one transmitter because of in-band emission and de-sensing problems. In case of fully overlapped areas, transmitters have almost the same set of associated receivers. Due to proximity of transmitters (e.g., FIG. 1C), there may be no significant de-sensing problems and a majority of associated receivers may successfully receive data from both transmitters.

The current application discloses improved systems, devices, and methods to improve D2D communication for public safety use cases. The embodiments and examples provided herein may improve D2D communication for partial and out-of-network coverage scenarios based on LTE technology. In this disclosure, applicants propose mechanisms to effectively manage in-band emission interference. In one embodiment, applicants propose establishing synchronization through synchronization sources and advertising recommended timeslots for data transmission. The principles of this disclosure may be applied in both centralized and distributed architecture.

In one embodiment, avoiding in-band emission issues may be accomplished by having transmitters transmitting in time resources that are orthogonal in time (e.g., the time resources do not overlap in time). In order to ensure that transmissions are independent in time, it may first be necessary to establish synchronization. For example, synchronization between public safety terminals operating in out-of-coverage scenarios may be established before D2D transmissions in order to manage time resources. Once synchronization is established, several nodes may periodically transmit synchronization signals and the public safety terminals may associate to one of these synchronization sources based on maximum received power or other criteria. Thus, the synchronization sources are synchronized with each other and each “owns” a part of the time resources of an LTE frame or aggregated LTE frames. Any transmitter that wants to broadcast data should select or be assigned to one of the frequency channels and transmit on the time resources that are indicated by the given synchronization source.

In one embodiment, hierarchical synchronization reference propagation is used to maximize a size of a synchronous area. For example, timing derived from a synchronization source may be propagated over multiple hops. As a further example, a reference signal received power (RSRP) threshold may be used to limit which terminals transmit synchronization signals to propagate timing derived from another synchronization source. In one embodiment, time division multiplexing may be used between derived synchronization sources. For example, different synchronization sources that are propagating the same timing may use independent time resources that do not overlap in time. In one embodiment, a synchronization source may advertise time multiplexed resources for selection by D2D transmitters. In one embodiment, frequency division multiplexing may be used on the bounds of synchronous areas to avoid strong co-channel asynchronous collisions. For example, the frequency division multiplexing may be applied on top of time division multiplexing. In one embodiment, a maximum limit on a number of hops may be used to limit the size of a synchronization area. In one embodiment, support for inter-synchronization area communication is supported to allow for effective communication over long distances.

The embodiments of the present disclosure provide benefits over currently available solutions. For example, the existing solutions either are non-synchronous or do not take into account the in-band emission effect. Specifically, previous solutions allow for transmissions in the whole bandwidth (time and/or frequency) and thus are limited by transmission range or co-channel/in-band interference.

In order to achieve synchronization, common timing should be established among multiple terminals with independent oscillators. Multiple approaches may be used to achieve synchronization in time. One solution is to use a distributed synchronization approach in which terminals periodically transmit synchronization signals and adjust their timing in an attempt to try to reach consensus in establishing common timing. However, such approaches typically require a large convergence time. An alternative solution is to use a hierarchical approach for synchronization. In this approach one of the terminals may autonomously take the role of an independent synchronization source (I-SS) and transmit D2D synchronization signals (D2DSS). Synchronization sources that are terminals may also be referred to as a peer radio head (PRH), synchronization cluster head, reference point, gateway synchronization source (G-SS), or the like. An I-SS terminal may be referred to as a PRH, synchronization cluster, head, reference point, or the like. It should also be noted that a base station, such as an eNB, can also act as an I-SS. Terminals that are in-range of the I-SS (a peer terminal or an eNB) can scan the air and synchronize to the I-SS which periodically broadcasts D2DSS. The term “independent” with regard to a synchronization source is given to mean that a terminal or PRH does not derive timing for transmission of D2D signals from any other synchronization source operating using an LTE air interface (e.g., does not derive from another terminal, eNB, or the like). However, an I-SS may derive timing from external sources, such as GPS, etc.

Once the PRH (or I-SS) starts transmission of synchronization signals a common timing is established among neighborhood devices. The neighborhood devices may include devices that are synchronized with the PRH and are within a synchronization range, which, in one embodiment, is up to −135 dB in path gain.

Next, the PRH/I-SS may find or instantiate additional sources of synchronization signals that derive timing from the PRH and further propagate it over a geographical area of the public safety network corresponding to an accident. These new sources of D2DSS are referred to herein as a G-SS. A G-SS may also be referred to herein as a PRH, a reference point, or the like. In one embodiment, selection of these new gateways or synchronization sources may be done in a distributed way based on distributed protocol for synchronization source selection, such as based on rules that define when a terminal or UE autonomously takes on a G-SS role. For instance, a UE may scan the air in order to detect D2DSS and/or physical D2D synchronization channel (PD2DSCH) communications transmitted by an I-SS. The UE may activate itself as a G-SS and start transmitting its own synchronization signals when the received power (RSRP) from the independent synchronization source and other synchronization gateways is below the predetermined inter-synchronization source RSRP threshold. The RSRP value may keep terminals that are too close to an I-SS from transmitting D2DSS.

In another embodiment, G-SSs are directly assigned by the I-SS/PRH. For example, G-SSs may be directly assigned by a PRH that serves as an I-SS. In one embodiment, any UE or terminal that implements functionality disclosed herein may serve as an I-SS or a G-SS.

In one embodiment, newly activated G-SSs will also transmit D2DSS synchronization signals periodically while maintaining synchronization with I-SS in order to keep synchronous operation in a given geographical area. For at least this reason, D2DSS transmitted by a PRH I-SS and PRH G-SS may be carried on orthogonal resources, so that they can receive synchronization and process synchronization signals from each other. In one embodiment, an I-SS and a G-SS may operate on the same frequency resources, but D2DSS muting patterns may be defined to allow processing of the D2DSS between synchronization sources.

Other terminals surrounding the PRH I-SS and PRH G-SS may track synchronization signals from these nodes and select the best node for synchronization. One of the criteria that can be used to select a synchronization source is to select the one that results in the maximum received power. In many cases this criterion will result in selection of the best and closest synchronization source. Following this procedure the synchronization will be established among all public safety terminals in the geographical area of an accident or public safety event. In general, timing propagation over two terminals or more may be established by selecting additional PRHs that derive timing from the G-SS PRHs.

In addition to establishing synchronization, different time slots (or other frequency resources) may be assigned to different PRHs (I-SS/G-SS) for data transmission in order to minimize the in-band emission effect. In one embodiment, UEs that derive timing from a particular PRH use the time resource associated with that PRH for data transmission.

It should be noted that, in practice, multiple public safety accidents may happen in close geographical areas. Thus, in order to avoid global propagation of synchronization timing, ability and rules for asynchronous operation may also be considered. For example, frequency division multiplexing may be applied between different I-SSs/G-SSs that belong to different synchronization areas. Thus, transmitters associated with a respective PRH may use a time and/or frequency resource associated with the respective PRH.

In one embodiment, a UE involved in D2D communication is able to periodically transmit D2DSS. However, before it starts D2DSS transmission, the UE may scan for active synchronization sources. If a synchronization source is not detected, then the UE may begin serving as an I-SS, which does not derive its own D2D transmission timing from any other node. In this case, the I-SS establishes its own synchronization area to initiate D2D operation with neighborhood devices. It should be noted that an I-SS may exist only in out-of-coverage or partial network coverage scenarios. If it happens that an in-coverage UE detects an I-SS, it may start transmitting its own D2DSS (autonomously or by direction of the eNB) in order to automatically mute the I-SS transmission.

For instance, a within network coverage UE (deriving its own timing from the eNB) may detect an I-SS and then inform the eNB and request D2DSS transmission or, alternatively, autonomously start transmission of D2DSS/PD2DSCH in allocated D2D resources in order to mute the I-SS. In this case, the UE will propagate eNBs timing to the I-SS UE and the I-SS may mute its own transmission of D2DSS causing asynchronous interference. This mechanism implies at least two-hop timing propagation, i.e., from eNB-to-UE and from UE-to-I-SS. The I-SS should mute its own D2DSS transmission and derive propagated timing once it has detected D2DSS from an in-coverage UE. The two-hop timing propagation mechanism can be also used to facilitate inter-cell D2D communication for the case of asynchronous or synchronous networks.

In multi-hop timing propagation analysis, three types of UE nodes can be classified in terms of synchronization procedure. A first type of UE node is an I-SS. The I-SS is a node which transmits D2DSS and does not derive its own timing from other synchronization sources. Its propagation hop count may be set to 0. A second type of UE node is a G-SS. The G-SS derives timing from I-SSs or other G-SSs and propagates timing to the UEs in the neighborhood by transmitting D2DSS. Its propagation hop count is in the range of 1 to N, where N is the maximum number of hops supported by the synchronization method/protocol. For two hops, N is equal to 1, and for three hops N is equal to 2. A third type of UE node is a receiver, which may be referred to as an RX-SS. The RX-SS detects and derives timing from an I-SS or G-SSs, but does not transmit D2DSS.

In order to benefit from synchronous direct communication among multiple terminals distributed over a large network deployment area, the synchronization area may need to be large. In the present disclosure, two approaches for timing propagation are presented below. Both approaches assume sequential-in-time and random location of terminals in a geographic area for terminals for public safety scenarios defined by RAN1 D2D Evaluation methodology.

A first approach includes multi-hop timing propagation from an I-SS and/or one or more G-SSs. According to this approach, a node (a terminal or UE) becomes an I-SS (with hop count=0) if it cannot detect other I-SSs or G-SSs. On the other hand, the node becomes a G-SS with hop count n if it can detect a G-SS node with a lower hop count (n−1) that is less than a maximum hop count. The node operates in an RX-SS state if it detects a G-SS with a maximum value of hop count (n=K−1, where K is the maximum number of hops). If a new node can hear several I-SSs, it becomes a G-SS with hop count 1 by selecting the best I-SS using RX power criteria. In one embodiment, a node only becomes a G-SS if the RSRP is less than a threshold value and/or greater than a minimum power level.

A second approach includes multi-hop I-SS and G-SS timing propagation with I-SS muting on the first hop. This approach is similar to the first approach, except muting occurs on the first hop. For example, when a new G-SS detects two or more I-SSs, it selects one of them as a synchronization source and starts transmitting D2DSS. The remaining I-SSs mute their operation when they detect a G-SS with hop count N=1 propagating from the neighboring I-SS. This muting procedure on the first hop may help to enlarge synchronization areas, since if two I-SSs appear in the neighborhood then several asynchronous areas may exist. In order to reduce the number of asynchronous areas, muting may be applied to the first hop or on additional hops. In one embodiment, the muting is limited to the first hop only to avoid destroying synchronization areas of large size.

In one embodiment, the first and second approaches above may also use a predefined RSRP threshold. In this case, the new node becomes a G-SS only if the received power from the nearest G-SS does not exceed a predefined threshold (e.g., −80 Decibel-milliwatts (dBm)). The hop count may be prioritized for synchronization source selection (for example, a lowest hop count PRH takes priority), then received power is used to select between synchronization sources with the lowest detected hop count. At the same time, the synchronization sources within a common synchronization area can decide on the time resources using a greedy algorithm. The allocated time resources may then be advertised or recommended to other transmitters for D2D communication.

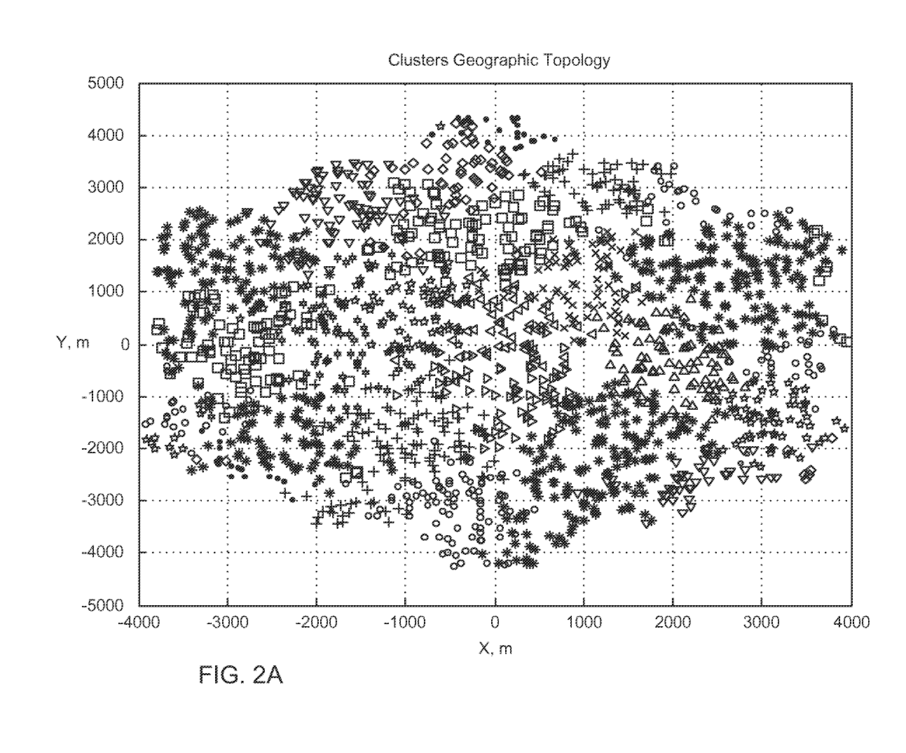

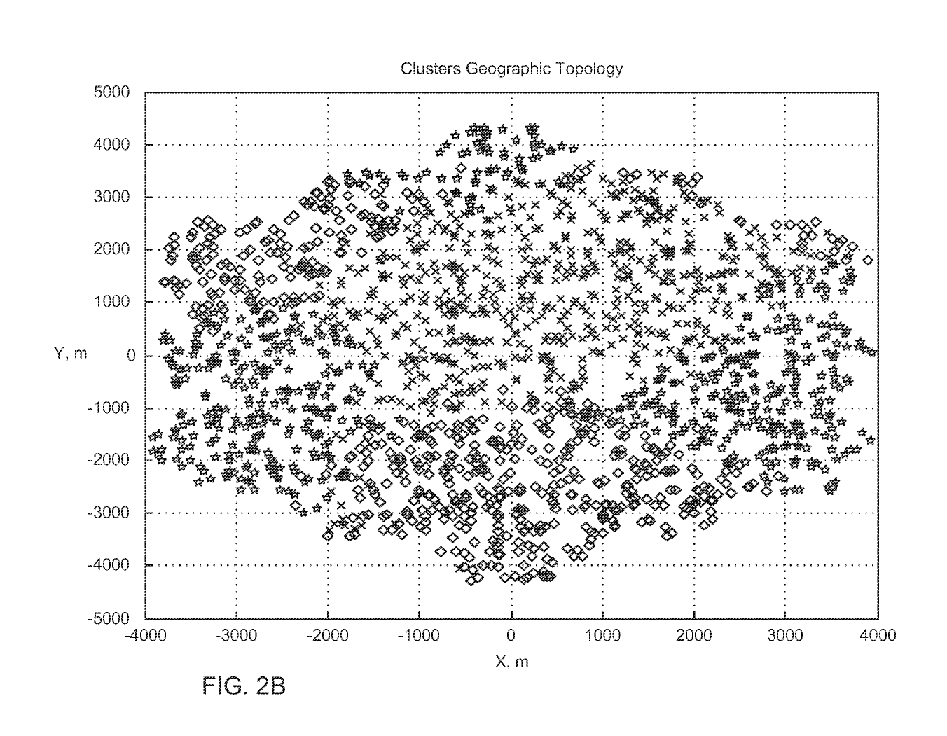

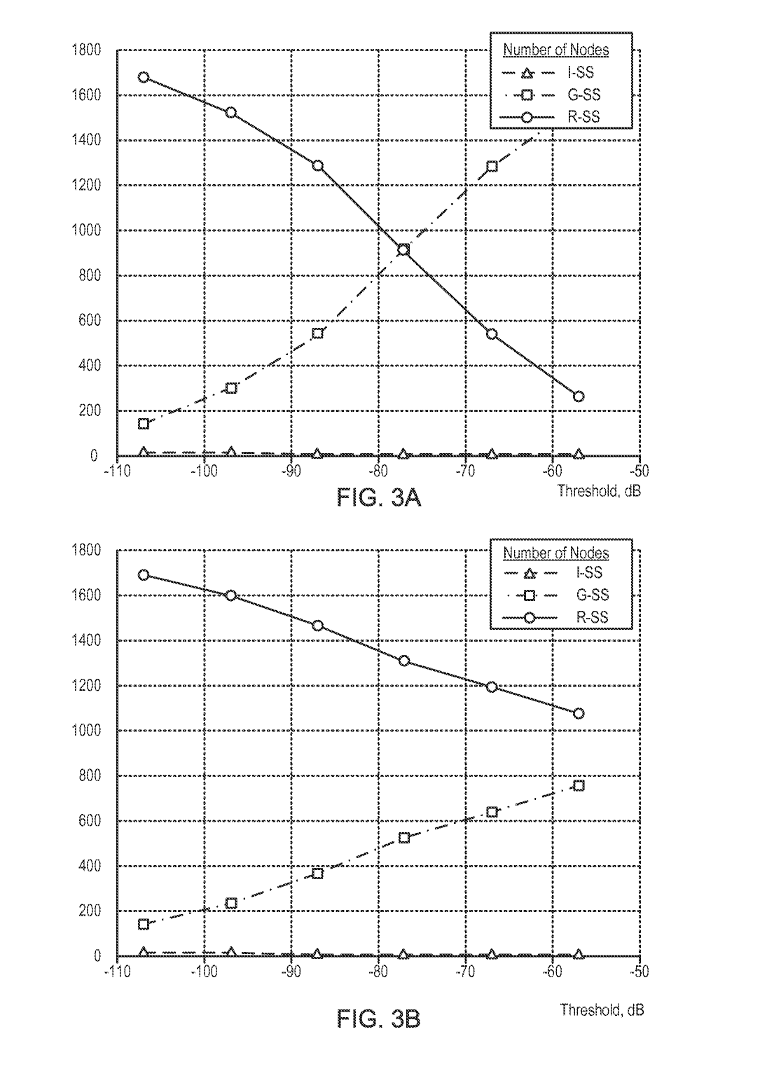

The approaches described above were evaluated using system-level simulation based on large-scale link parameters. The system-level evaluation parameters were taken from 3GPP TR 36.843, section A.2.1. The figures below demonstrate differences in synchronization clusters topology resulting from the first approach and the second approach. Specifically, FIG. 2A shows the result of synchronization based on three-hop propagation timing without muting. FIG. 2B shows the result of synchronization based on three-hop propagation with muting. In FIGS. 2A and 2B, the symbols represent UE and like symbols in proximity represent symbols that are synchronized. The second approach shown in FIG. 2 produces a reduced number of synchronization clusters (and larger synchronization areas) that lead to a reduction of asynchronous interference impact. Since any UE is allowed to transmit the synchronization signal in approach 1, and may not be muted, a large number of G-SSs are observed during the simulations. The number of I-SS/G-SS/R-SS is provided below in relation to FIGS. 3A and 3B.

The mechanism to reduce the number of G-SSs proposed above using an RSRP threshold value was evaluated for multiple RSRP threshold values. As can be seen in the graphical diagrams of FIGS. 3A and 3B, which are provided for the uniform and hotspot UE drop cases, the number of G-SSs significantly drops and the number of RX-SSs increases with threshold decrease. The G-SS number decrease leads to a reduction of synchronous interference between synchronization signals and thus may potentially provide more accurate timing synchronization between G-SS and R-SS nodes.

The set of I-SS/G-SS nodes established during synchronization may further be used for assistance during resource allocation assignment to transmitters that belong to the same synchronization cluster. Since the number of synchronization hops is limited, the synchronization clusters boundaries exist and thus some UEs may suffer from asynchronous interference coming from a neighboring cluster.

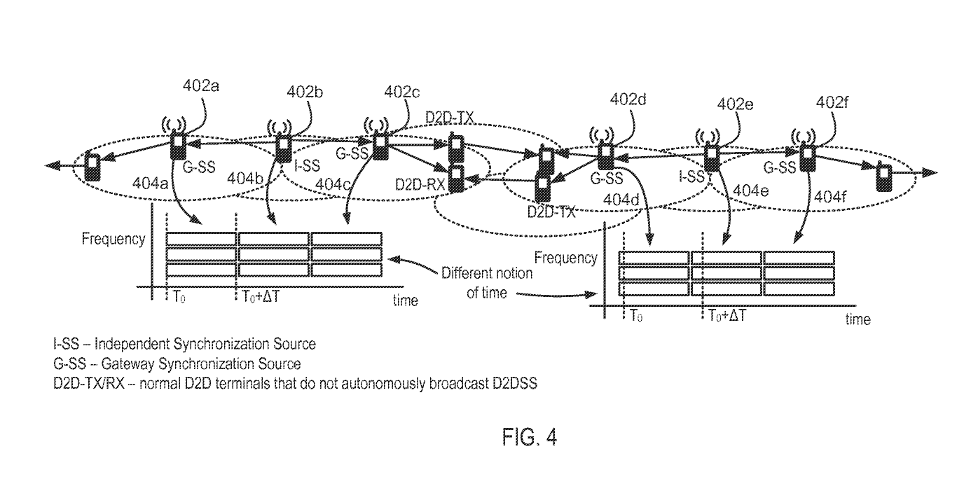

FIG. 4 is a schematic diagram illustrating variations in timing between different clusters of UEs in case of two-hop hierarchical timing propagation. In one embodiment, each I-SS transmits synchronization information to neighboring UEs, including G-SSs. The G-SSs further propagate the timing to any receiving or transmitting UEs (e.g., D2D-TX and D2D-RX shown). For example, G-SS 402a and 402b derive timing from I-SS 402b and further propagate the timing to other UEs. Similarly, G-SS 402d and 402f derive timing from I-SS 402e. Synchronization boundaries may exist between UEs on the left side of the diagram (I-SS 402b and G-SSs 402a and 402c) and UEs on the right side of the diagram (I-SS 402e and G-SSs 402d and 402f). Asynchronous communication may be used for transmitters and receivers located on the synchronization boundaries. In addition to propagating timing, the I-SS and G-SS may notify neighboring UEs of a resource allocation to be used for D2D data communications. For example, G-SS 402a uses time resource 404a, I-SS 402b uses time resource 404b, and G-SS 402c uses time resource 404c. Similarly, G-SS 402d uses time resource 404d, I-SS 402e uses time resource 404e, and G-SS 402f uses time resource 404f.

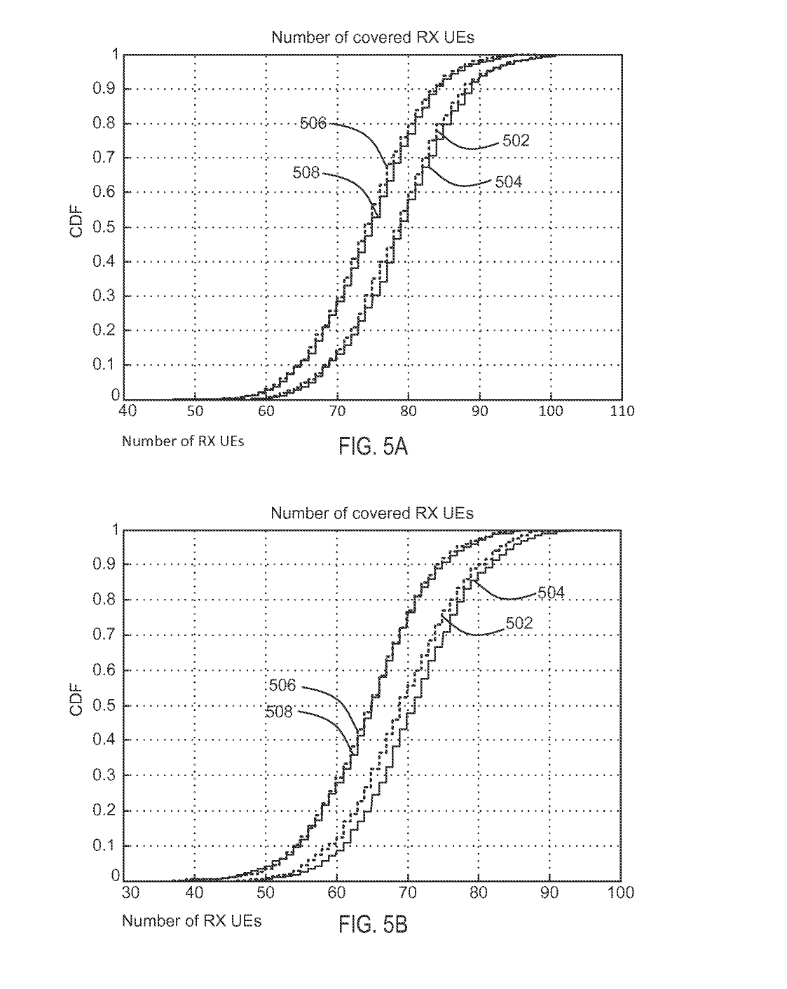

FIGS. 5A and 5B illustrate the impact of asynchronous interference on the number of users covered by each broadcast transmitter. The proposed synchronization clustering mechanism with three-hop synchronization signal propagation was used to form synchronization clusters and I-SS/G-SS node assignments. FIG. 5A illustrates the cumulative distribution function (CDF) of a number of covered receiving UEs per transmitter for three transmitters per sector. FIG. 5B illustrates the CDF of a number of covered receiving UEs per transmitter for nine transmitters per sector. Curves 502, in both FIGS. 5A and 5B, represent the CDF for time division multiplexing (TDM) assistance by synchronization source (TA-SS) using the hierarchal synchronization systems and methods discussed herein. Curves 504 represent the CDF for TA-SS with full synchronization (the ideal case). Curves 506 represent the CDF using a greedy algorithm and hierarchical synchronization. Curves 508 represent the CDF using a greedy algorithm and full synchronization. Note that curves 502 represents the number of UEs covered by a single broadcast transmitter with resource allocation assistance provided by I-SS and/or G-SS nodes, as discussed herein. As it can be seen, the number of covered UEs in this case is close to an ideal case of whole deployment synchronization, as represented by curves 504

In general, synchronization area boundaries are inevitable using multi-hop synchronization signal and resource information propagation with a limit on the number of hops. In order to support communication between devices across neighboring synchronization areas, the limit on the multi-hop propagation can be generally applied so that synchronization signals and associated resources that correspond to synchronization signals received with the maximum number of hops will be used only for reception on these resources and not for further propagation or transmission on these resources. On the other hand, synchronization signals received with less than the maximum number of hops may be used for further propagation of synchronization and/or transmission and may be allowed on resources associated with these synchronization signals.

According to this principle, in one embodiment using a three-hop maximum, if a D2D UE receives a PD2DSS with four hops, then it can use the associated timing and resources only for reception of transmission on these resources, but not transmit on these resources or propagate this timing further. However, if it receives PD2DSS with three hops, then it can propagate the timing further (following the rules described above) and/or transmit on the associated resources.

The unique combination of the proposed techniques disclosed herein can substantially improve VoIP performance in out-of-coverage public safety specific use cases and allow multiple receivers to receive VoIP traffic from multiple active transmitters.

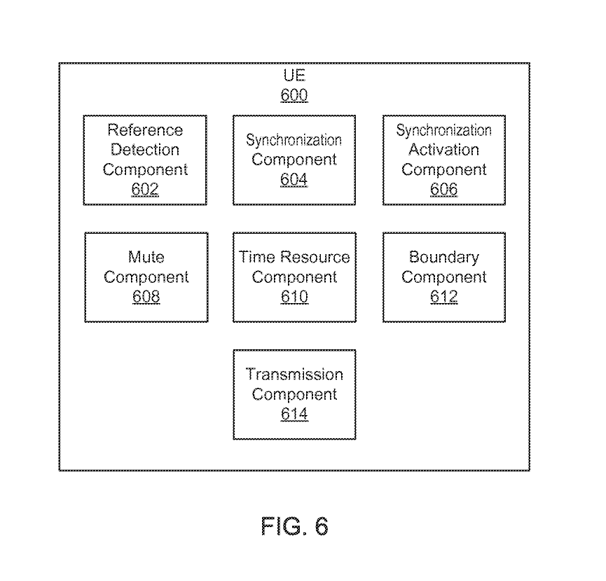

FIG. 6 is a schematic block diagram of a UE 600 configured to operate according to one or more of the synchronization schemes and resource allocation schemes discussed herein. The UE 600 may selectively operate as an I-SS, a G-SS, and/or an RX-SS. The UE 600 includes a reference detection component 602, a synchronization component 604, a synchronization activation component 606, a mute component 608, a time resource component 610, a boundary component 612, and a transmission component 614.

The reference detection component 602 is configured to detect one or more synchronization references, such as an I-SS, a G-SS, or the like. For example, the reference detection component 602 may listen for synchronization signals after powering on. In one embodiment, the reference detection component 602 may listen for D2DSS transmitted by an I-SS that includes an eNB or a peer UE. For example, when the UE 600 is within network coverage, the reference detection component 602 may detect a synchronization signal from an eNB. On the other hand, when the UE 600 is outside network coverage, the reference detection component 602 may detect a reference signal from an out-of-coverage peer UE that is serving as an I-SS or a G-SS.

In one embodiment, the reference detection component 602 is configured to detect two or more synchronization sources and to select one of the sources for synchronization. In one embodiment, the reference detection component 602 determines which synchronization source to select based on a signal strength of the first synchronization signal meeting a predefined threshold. For example, synchronization sources with stronger signal strengths may be prioritized. Some embodiments may include more than one threshold to avoid hysteresis. For example, there may be one threshold and reference detection component 602 may monitor certain times during which the signal should be below or above a threshold. As another example, two thresholds can be also used to ensure that the signal strength is within a desired range.

In one embodiment, the reference detection component 602 selects a synchronization source based on whether the synchronization source is an I-SS (e.g., versus a G-SS). In one embodiment, reference detection component 602 selects a reference point based on a hop count for the reference point or a transmitted signal. In one embodiment, the hop count indicates how many intervening synchronization sources (such as G-SSs) are located between the terminal and an I-SS from which the synchronization information is derived. In one embodiment, the reference detection component 602 selects a synchronization source based on the timing information being directly or indirectly derived from a base station, such as an eNB. For example, even if there is another reference point having a better signal strength or lower hop count, the reference detection component 602 may select a reference point that is directly or indirectly deriving timing from a cellular network.

In one embodiment, the reference detection component 602 is configured to determine that no I-SSs, and/or G-SSs, are detected. Determining whether other synchronization sources are detected may be helpful for determining whether the UE should begin serving as an I-SS, a G-SS, or an RX-SS.

The synchronization component 604 is configured to synchronize with a reference point, such as PRH. In one embodiment, the synchronization component 604 is configured to synchronize with an I-SS based on a synchronization signal received from the I-SS. In one embodiment, the synchronization component 604 is configured to synchronize with a synchronization source selected by the reference detection component 602. In one embodiment, the synchronization component 604 is configured to receive the synchronization signal and synchronize a timing and/or frequency with the synchronization source based on the synchronization signal.

The synchronization activation component 606 is used to activate the UE 600 or another UE as a synchronization source. In one embodiment, the synchronization activation component 606 is configured to determine when to autonomously begin serving as an I-SS or a G-SS. For example, the synchronization activation component 606 may activate the UE 600 as an I-SS when no other synchronization signals above a predefined threshold value are detected. In one embodiment, the synchronization activation component 606 may determine whether a received signal strength from an I-SS is below a threshold value. The received signal strength may be below the threshold value but above a minimum value, such as the −135 dB discussed herein. In one embodiment, in response to determining that the signal strength for an I-SS or a G-SS is below the threshold value, the synchronization activation component 606 activates the UE 600 as a G-SS in order to begin transmitting a synchronization signal to propagate the synchronization information derived from the other synchronization source. In one embodiment, the UE 600 may be located within network coverage and may be deriving timing from an eNB. The synchronization activation component 606 may activate the UE 600 as a G-SS to propagate the timing to one or more peer UE out of range of the eNB (or other I-SS). For example, activating the UE 600 as a synchronization source may include beginning to send D2DSS.

In one embodiment, the synchronization activation component 606 autonomously activates the UE 600 as a synchronization source in response to determining that a hop count is less than a predetermined maximum hop count. The synchronization activation component 606 may also require that the received synchronization signal is below and/or above predefined thresholds.

In one embodiment, the synchronization activation component 606 is configured to activate the UE 600 as a G-SS or other synchronization source in response to receiving a signal explicitly activating the UE as a synchronization source. For example, the synchronization activation component 606 may receive a signal from a synchronization source activating the UE as a G-S S.

In one embodiment, the synchronization activation component 606 is configured to select and/or activate another UE to serve as a synchronization source. For example, a G-SS or an I-SS may identify a UE having a proper signal strength, etc. to serve as a synchronization source. In one embodiment, the synchronization activation component 606 selects a peer wireless communication device to propagate timing information based on first timing information received from the UE 600. In one embodiment, the synchronization activation component 606 causes the UE 600 to send a signal to the peer wireless communication device to activate the peer wireless communication device as a synchronization source. The synchronization activation component 606 may also select additional devices to act as synchronization sources.

The mute component 608 is configured to mute transmission of synchronization signals, such as D2DSS. For example, if the UE 600 is serving as an I-SS or a G-SS, the mute component 608 may determine whether the UE 600 should stop serving as the I-SS or G-SS. In one embodiment, another UE may send a synchronization signal that indicates a priority of an I-SS from which timing is derived, a hop count, or other information. The mute component 608 may determine that the received synchronization signal has a higher priority and mute transmission of D2DSS. This functionality may allow synchronization sources with a priority lower than the priority of the I-SS to mute transmissions to reduce asynchronous areas and increase the size of a synchronous area. In one embodiment, the mute component 608 is configured to stop transmission of synchronization information in response to receiving a synchronization signal with synchronization information that is based on timing information from a higher priority synchronization source. The priority of the synchronization source may be based on whether the timing is derived from a network entity (such as a base station or eNB) or on a hop count.

The time resource component 610 is configured to determine time resources available for data transmission. For example, the time resource component 610 may enable a time division multiplexing communication to ensure that in-band emissions are limited or reduced. In one embodiment, the time resource component 610 is configured to determine the time resources based on a synchronization source to which the UE 600 is synchronizing. For example, the time resource or time slot may correspond to a synchronization source selected by the reference detection component 602. In one embodiment, the time resource component 610 is configured to determine a time resource associated with the UE 600 that is different in time from a second synchronization source that is synchronized with the I-SS. For example, if the UE 600 is serving as a G-SS, the time resource component 610 may select a time resource that is not used by another G-SS or an I-SS. In one embodiment, the time resource component 610 is configured to determine a time resource assigned to the UE, wherein the time resource does not overlap in time with time resources assigned to another synchronization source. In one embodiment, if the UE 600 is operating as an RX-SS, the time resource component 610 may determine a time resource associated with a synchronization source from which timing is derived.

In one embodiment, the time resource component 610 determines the time resource in response to a signal strength of the synchronization signal exceeding a predefined threshold value.

In one embodiment, if the UE 600 is operating as an I-SS or G-SS, the time resource component 610 may assign a time resource to a lower priority (higher hop count) peer UE for data transmissions. In one embodiment, the time resource does not overlap in time with a time resource associated with the UE 600 or another synchronization source that is synchronized with the UE 600.

The boundary component 612 is configured to determine whether the UE 600 is near a boundary of a synchronous area. For example, the boundary component 612 may determine whether the UE 600 is located near a boundary of a synchronization area based on one or more of a hop count and/or a received signal strength from the first synchronization source. As a further example, if the hop count for the UE 600 is a maximum (or greater than the maximum) value of hops and/or a received signal strength from a synchronization source is below a threshold, the boundary component 612 may determine that the UE 600 is near the boundary. In one embodiment, the boundary component 612 may determine that frequency division multiplexing may be needed in addition to time division multiplexing to limit interference with another synchronization area. For example, the UE 600 may transmit the data during time resources determined by the time resource component 610 and within a frequency resource less than an available frequency resource for transmission. In one embodiment, the boundary component 612 may detect transmission by UEs in a different synchronization cluster to determine which frequencies should be used to reduce interference.

The transmission component 614 is configured to transmit signals and information for the UE 600 and other components 602-612 of the UE 600. In one embodiment, the transmission component 614 transmits synchronization signals to propagate timing information and synchronize with neighboring D2D UEs. In one embodiment, the transmission component 614 transmits or advertises time resource information for time resources used by the UE 600 or assigning time resources to be used by another device. In one embodiment, the transmission component 614 transmits a signal activating another UE as a synchronization source. In one embodiment, the transmission component 614 transmits an indication of a hop count for the UE 600. For example, the hop count information may be included in a D2DSS. In one embodiment, the transmission component 614 may transmit other information regarding a priority of the UE 600 or an I-SS from which the UE 600 derives timing information.

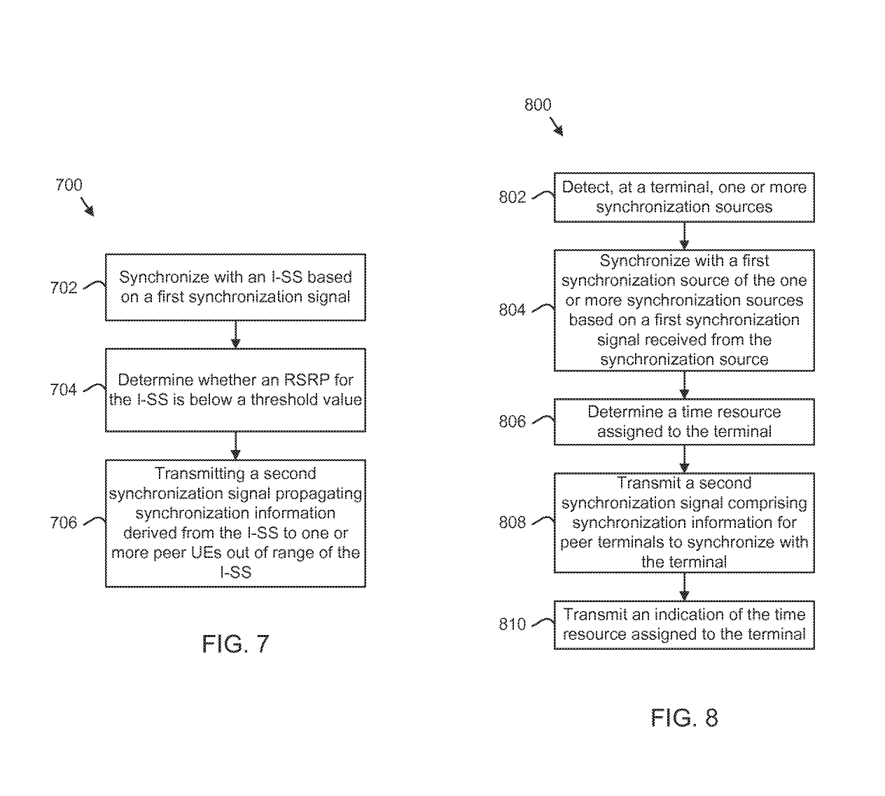

FIG. 7 is a schematic flow chart diagram illustrating an example method 700 for hierarchal D2D synchronization. The method 700 may be performed by a wireless communication device, such as the UE 600 of FIG. 6.

The method 700 begins and the synchronization component 604 synchronizes 702 with an I-SS based on a synchronization signal received from the I-SS. The synchronization activation component 606 determines 704 whether a received signal strength from the I-SS is below a threshold value. In one embodiment, the synchronization activation component 606 activates the UE 600 as a synchronization source.

In response to determining 704 that the received signal strength is below the threshold value, the transmission component 614 transmits 706 a second synchronization signal propagating synchronization information derived from the I-SS to one or more peer UEs out of range of the I-SS.

FIG. 8 is a schematic flow chart diagram illustrating an example method 800 for hierarchal D2D synchronization and resource allocation. The method 800 may be performed by a terminal, such as the UE 600 of FIG. 6.

The method 800 begins and the reference detection component 602 detects 802 one or more synchronization sources. The synchronization component 604 synchronizes with a first synchronization source of the one or more synchronization sources. The time resource component 610 determines 806 a time resource assigned to the terminal. In one embodiment, the time resource does not overlap in time with time resources assigned to the first synchronization source.

A transmission component 614 transmits 808 a second synchronization signal that includes synchronization information for peer terminals to synchronize with the terminal. The synchronization information is based on the first synchronization signal. The transmission component 614 transmits 810 an indication of the time resource assigned to the terminal.

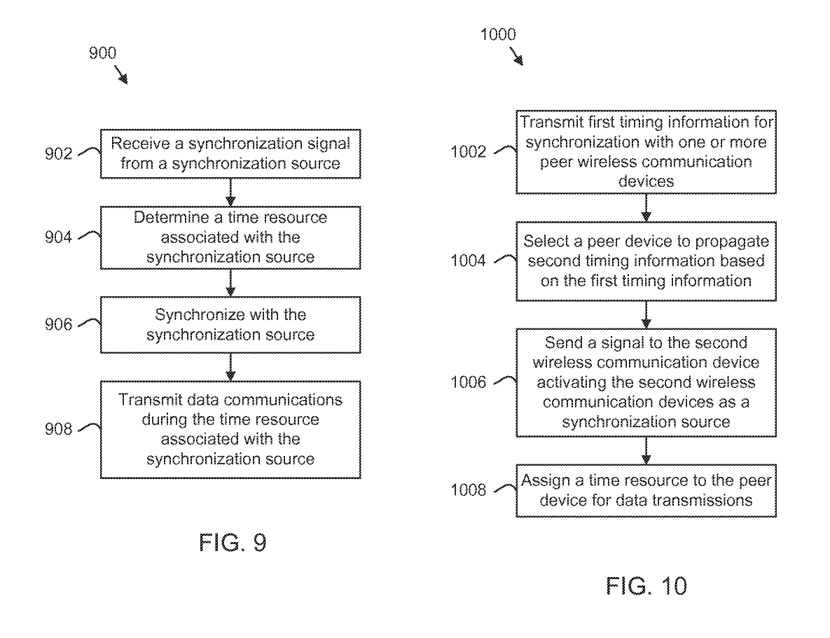

FIG. 9 is a schematic flow chart diagram illustrating an example method 900 for hierarchal D2D synchronization and resource allocation. The method 900 may be performed by a terminal, such as the UE 600 of FIG. 6.

The method 900 begins and the synchronization component 604 receives 902 a synchronization signal from a synchronization source. The time resource component 610 determines 904 a time resource associated with the synchronization source. The synchronization component 604 synchronizes 906 with the synchronization source based on the synchronization signal.

The transmission component 614 transmits 908 data communications during the time resource associated with the synchronization source. In one embodiment, the transmission component 614 does not transmit data communications outside of the time resource associated with the synchronization source during a time period during which the UE 600 synchronizes with the synchronization source.

FIG. 10 is a schematic flow chart diagram illustrating an example method 1000 for hierarchal D2D synchronization and resource allocation. The method 1000 may be performed by a terminal, such as the UE 600 of FIG. 6.

The method 1000 begins and the transmission component 614 transmits 1002 first timing information for synchronization with one or more peer wireless communication devices. The synchronization activation component 606 selects 1004 a wireless communication device of the one or more peer wireless communication devices to propagate second timing information based on the first timing information. The transmission component 614 sends 1006 a signal to the wireless communication device activating the wireless communication devices as a synchronization source.

The time resource component 610 assigns 1008 a time resource to the wireless communication device for data transmissions. For example, the transmission component 614 may transmit a message advertising the time resource assigned to the wireless communication device. In one embodiment, the time resource does not overlap in time with a time resource associated with the terminal or another synchronization source that is synchronized with the terminal.

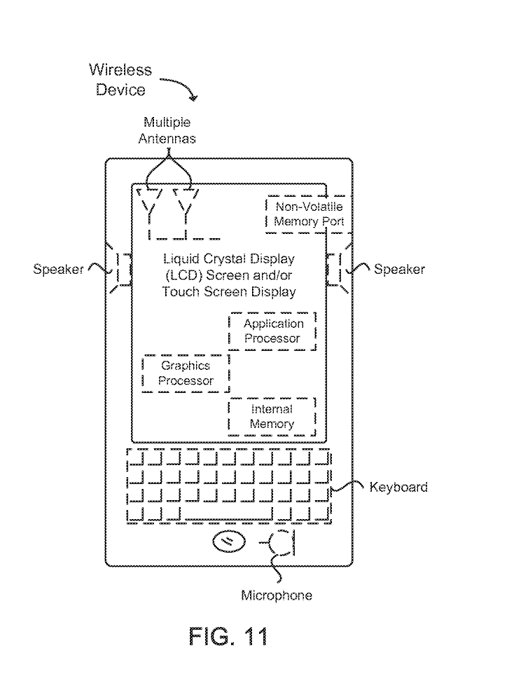

FIG. 11 provides an example illustration of a mobile device, such as a UE, a mobile station (MS), a mobile wireless device, a mobile communication device, a tablet, a handset, or another type of mobile wireless device. The mobile device may include one or more antennas configured to communicate with a node, macro node, low power node (LPN), or transmission station, such as a base station (BS), an eNB, a base band unit (BBU), a remote radio head (RRH), a remote radio equipment (RRE), a relay station (RS), radio equipment (RE), or another type of wireless wide area network (WWAN) access point (AP). The mobile device may be configured to communicate using at least one wireless communication standard, including 3GPP LTE, WiMAX, High Speed Packet Access (HSPA), Bluetooth, and Wi-Fi. The mobile device may communicate using separate antennas for each wireless communication standard or shared antennas for multiple wireless communication standards. The mobile device may communicate in a wireless local area network (WLAN), a wireless personal area network (WPAN), and/or a WWAN.

FIG. 11 also provides an illustration of a microphone and one or more speakers that may be used for audio input and output from the mobile device. The display screen may be a liquid crystal display (LCD) screen or other type of display screen, such as an organic light emitting diode (OLED) display. The display screen may be configured as a touch screen. The touch screen may use capacitive, resistive, or another type of touch screen technology. An application processor and a graphics processor may be coupled to internal memory to provide processing and display capabilities. A non-volatile memory port may also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

### Examples

The following examples pertain to further embodiments.

Example 1 is a UE configured to synchronize with an I-SS based on a first synchronization signal received from the I-SS. The UE is configured to determine whether a received signal strength from the I-SS is below a threshold value. The UE is configured to, in response to determining that the I-SS is below the threshold value, transmit a second synchronization signal propagating synchronization information derived from the I-SS to one or more peer UE out of range of the I-SS. The second synchronization signal includes a D2DSS.

In Example 2, the I-SS of Example 1 includes an eNB, and the one or more peer UEs are in partial network coverage.

In Example 3, the second synchronization signal of any of Examples 1-2 indicates a priority of the I-SS. The synchronization sources forwarding synchronization information derived from a synchronization source with a priority lower than the priority of the I-SS mute transmission of synchronization signals in response to receiving the second synchronization signal.

In Example 4, the I-SS of any of Examples 1-3 include a peer UE that is outside network coverage.

In Example 5, the UE of any of Examples 1-4 is further configured to determine a time resource associated with the UE that is different in time than a second synchronization source that is synchronized with the I-SS.

In Example 6, the UE of any of Examples 1-5 is further configured to advertise the time resource associated with the UE.

Example 7 is a terminal that includes a reference detection component, a synchronization component, a time resource component, and a transmission component. The reference detection component is configured to detect one or more synchronization sources. The synchronization component is configured to synchronize with a first synchronization source of the one or more synchronization sources based on a first synchronization signal received from the first synchronization source. The first synchronization source is associated with first synchronization resources used by the one or more synchronization sources. The time resource component is configured to determine a time resource assigned to the terminal. The time resource does not overlap in time with time resources assigned to the first synchronization source. The transmission component is configured to transmit a second synchronization signal comprising synchronization information for peer terminals to synchronize with the terminal. The synchronization information is based on the first synchronization signal. The transmission component is configured to transmit an indication of the time resource assigned to the terminal.

In Example 8, the transmission component of Example 7 is configured to transmit the second synchronization signal in response to determining that a hop count is less than a predetermined maximum hop count. The hop count indicates how many G-SSs are located between the peer terminal and an independent primary radio head from which synchronization information of the first synchronization signal is derived.

In Example 9, the transmission component of any of Examples 7-8 is further configured to transmit a hop count for the second synchronization signal.

In Example 10, the terminal of any of Examples 7-9 further includes a mute component configured to stop transmission of synchronization information in response to receiving a synchronization signal with synchronization information that is based on timing information from a higher priority synchronization source.

In Example 11, the reference detection component of any of Examples 7-10 is configured to detect one or more synchronization sources including two or more synchronization sources. The synchronization component is configured to synchronize with the first synchronization source based on one or more of: a signal strength of the first synchronization signal meeting a predefined threshold; the first synchronization source comprising an independent synchronization source (I-SS); the first synchronization signal comprises timing information directly or indirectly derived from a base station; and a hop count for the first synchronization signal, wherein the hop count indicates how many intervening synchronization sources are located between the terminal and an I-SS from which the synchronization information in the first synchronization signal is derived.

Example 12 is a UE configured to receive a synchronization signal from a synchronization source. The UE is configured to determine a time resource associated with the synchronization source. The UE is configured to synchronize with the synchronization source based on the synchronization signal. The UE is configured to transmit data communications during the time resource associated with the synchronization source. The UE does not transmit data communications outside of the time resource associated with the synchronization source during a time period during which the UE synchronizes with synchronization source.

In Example 13, the UE of Example 12 is further configured determine whether the UE is located near a boundary of a synchronization area based on one or more of a hop count and/or a received signal strength from the first synchronization source.

In Example 14, the UE of any of Examples 11-12 is further configured to, in response to determining that the UE is located near the boundary, transmit the data communications during the time resources and within frequency resource less than an available frequency resource for transmission.

In Example 15, determining the time resource and synchronizing in any of Examples 11-13 includes determining the time resource and synchronizing in response to a signal strength of the synchronization signal exceeding a predefined threshold value.

In Example 16, the synchronization source of any of Examples 11-14 includes a first synchronization source and the synchronization signal includes a first synchronization signal. The UE is further configured to receive a signal from the first synchronization source activating the UE as a G-SS and transmit additional synchronization signals comprising timing based on the first synchronization signal from the first synchronization source.

Example 17 is a method that includes synchronizing a UE with an I-SS based on a first synchronization signal received from the I-SS. The method includes determining whether a received signal strength from the I-SS is below a threshold value. The method includes, in response to determining that the I-SS is below the threshold value, transmitting a second synchronization signal propagating synchronization information derived from the I-SS to one or more peer UE out of range of the I-SS. The second synchronization signal includes a D2DSS.

In Example 18, the I-SS of Example 17 includes an eNB, and the one or more peer UEs are in partial network coverage.

In Example 19, the second synchronization signal of any of Examples 17-18 indicates a priority of the I-SS. Synchronization sources forwarding synchronization information derived from a synchronization source with a priority lower than the priority of the I-SS mute transmission of synchronization signals in response to receiving the second synchronization signal.

In Example 20, the I-SS of any of Examples 17-19 includes a peer UE that is outside network coverage.

Example 21 is a method that includes detecting, at a terminal, one or more synchronization sources. The method includes synchronizing with a first synchronization source of the one or more synchronization sources based on a first synchronization signal received from the first synchronization source. The first synchronization source is associated with first synchronization resources used by the one or more synchronization sources. The method includes determining a time resource assigned to the terminal, wherein the time resource does not overlap in time with time resources assigned to the first synchronization source. The method includes transmitting a second synchronization signal including synchronization information for peer terminals to synchronize with the terminal. The synchronization information is based on the first synchronization signal. The method includes transmitting an indication of the time resource assigned to the terminal.

In Example 22, transmitting the second synchronization signal in Example 21 includes transmitting in response to determining that a hop count is less than a predetermined maximum hop count. The hop count indicates how many G-SSs are located between the peer terminal and an independent primary radio head from which synchronization information of the first synchronization signal is derived.

In Example 23 the method of any of Examples 21-22 further includes transmitting a hop count for the second synchronization signal.

In Example 23, the method of any of Examples 21-23 further include stopping transmission of synchronization information in response to receiving a synchronization signal with synchronization information that is based on timing information from a higher priority synchronization source.

In Example 24, detecting one or more synchronization sources in any of Examples 21-23 includes detecting two or more synchronization sources. Synchronizing with a first synchronization source comprises synchronizing based on one or more of: a signal strength of the first synchronization signal meeting a predefined threshold; the first synchronization source comprising an independent synchronization source (I-SS); the first synchronization signal comprises timing information directly or indirectly derived from a base station; and a hop count for the first synchronization signal, wherein the hop count indicates how many intervening synchronization sources are located between the terminal and an I-SS from which the synchronization information in the first synchronization signal is derived.

Example 25 is a method that includes receiving, at a UE, a synchronization signal from a synchronization source. The method includes determining a time resource associated with the synchronization source. The method includes synchronizing with the synchronization source based on the synchronization signal. The method includes transmitting, using the UE, data communications during the time resource associated with the synchronization source. The UE does not transmit data communications outside of the time resource associated with the synchronization source during a time period during which the UE synchronizes with synchronization source.

In Example 26, the method of Example 25 further includes determining whether the UE is located near a boundary of a synchronization area based on one or more of a hop count and/or a received signal strength from the first synchronization source.

In Example 27, the method of any of Examples 25-26 further includes, in response to determining that the UE is located near the boundary, transmitting the data communications during the time resources and within frequency resource less than an available frequency resource for transmission.

In Example 28, determining the time resource and synchronizing in any of Examples 25-27 includes determining the time resource and synchronizing in response to a signal strength of the synchronization signal exceeding a predefined threshold value.

In Example 29, the synchronization source in any of Examples 25-28 includes a first synchronization source and the synchronization signal includes a first synchronization signal. The method further includes receiving a signal from the first synchronization source activating the UE as a G-SS and transmitting additional synchronization signals comprising timing based on the first synchronization signal from the first synchronization source.

Example 30 is a method that includes transmitting, by a first wireless communication device, first timing information for synchronization with one or more peer wireless communication devices. The method includes selecting a second wireless communication device of the one or more peer wireless communication devices to propagate second timing information based on the first timing information. The method includes sending, by the first wireless communication device, a signal to the second wireless communication device activating the second wireless communication devices as a synchronization source. The method includes assigning a time resource to the second wireless communication device for data transmissions. The time resource does not overlap in time with a time resource associated with the first wireless communication device or another synchronization source that is synchronized with the first wireless communication device.

In Example 31, the method of Example 30 further includes listening for one or more synchronization sources and determining that no I-SS is detected. Transmitting the first timing information comprises transmitting in response to determining that no I-SS is detected.

In Example 32, the method of any of Examples 30-31, further includes selecting a third peer wireless communication device of the one or more peer wireless communication devices to propagate third timing information based on the first timing information. The method further includes sending a signal to the third peer wireless communication device activating the third peer wireless communication devices as a synchronization source. The method further includes assigning a third time resource to the third peer wireless communication device for data transmissions, wherein the third time resources does not overlap in time with time resources associated with the first wireless communication device or second wireless communication device.

In Example 33, the method of any of Examples 30-32 further include transmitting an indication of a hop count for the first wireless communication device.

Example 34 is an apparatus including means to perform a method of any of Examples 17-33.

Example 35 is machine readable storage including machine-readable instructions which, when executed, implement a method or realize an apparatus of any of Examples 17-34.

Various techniques, or certain aspects or portions thereof, may take the form of program code (i.e., instructions) embodied in tangible media, such as floppy diskettes, CD-ROMs, hard drives, a non-transitory computer readable storage medium, or any other machine readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

1-20. (canceled)

21. An apparatus for a user equipment (UE), comprising:
one or more processors configured to:
synchronize with an independent synchronization source (I-SS) based on a first synchronization signal received from the I-SS;
determine whether a received signal strength from the I-SS is below a threshold value; and
transmit a second synchronization signal propagating synchronization information derived from the I-SS to one or more peer UEs out of range of the I-SS, if the I-SS is below the threshold value,
wherein the second synchronization signal comprises a device-to-device synchronization signal (D2DSS).

22. The apparatus of claim 21, wherein the I-SS comprises an Evolved Universal Terrestrial Radio Access Network (E-UTRAN) Node B (eNB), and wherein the one or more peer UEs are in partial network coverage.

23. The apparatus of claim 21, wherein the second synchronization signal indicates a priority of the I-SS, and wherein synchronization sources forwarding synchronization information derived from a synchronization source with a priority lower than the priority of the I-SS mute transmission of synchronization signals in response to receiving the second synchronization signal.

24. The apparatus of claim 21, wherein the I-SS comprises a peer UE that is outside network coverage.

25. The apparatus of claim 21, wherein the I-SS comprises a first synchronization source, and wherein the one or more processor are further configured to determine a time resource associated with the UE that is different in time than a second synchronization source that is synchronized with the I-SS.

26. The apparatus of claim 25, wherein the one or more processor are further configured to advertise the time resource associated with the UE.

27. The apparatus of claim 21, wherein the one or more processor are further configured to determine whether the UE is located near a boundary of a synchronization area based on one or more of a hop count and/or a received signal strength from the I-SS.

28. The apparatus of claim 27, wherein the one or more processor are further configured to transmit data communications during time resources and within frequency resources less than an available frequency resource for transmission, if the UE is located near the boundary.

29. The apparatus of claim 28, wherein to determine the time resource and to synchronize, the one or more processor are further configured to determine the time resource and synchronize in response to a signal strength of the first synchronization signal exceeding a predefined threshold value.

30. The apparatus of claim 21, wherein the I-SS comprises a first synchronization source, wherein the one or more processors are further configured to:
receive a signal from the first synchronization source activating the UE as a gateway synchronization source (G-SS); and
transmit additional synchronization signals comprising timing based on the first synchronization signal from the first synchronization source.

31. A user equipment (UE), comprising:
a synchronization block to synchronize with an independent synchronization source (I-SS) based on a first synchronization signal received from the I-SS;
a detection block to determine whether a received signal strength from the I-SS is below a threshold value; and
an activation block to transmit a second synchronization signal propagating synchronization information derived from the I-SS to one or more peer UEs out of range of the I-SS, if the I-SS is below the threshold value,
wherein the second synchronization signal comprises a device-to-device synchronization signal (D2DSS).

32. The UE of claim 31, wherein the I-SS comprises an Evolved Universal Terrestrial Radio Access Network (E-UTRAN) Node B (eNB), and wherein the one or more peer UEs are in partial network coverage.

33. The UE of claim 31, wherein the second synchronization signal indicates a priority of the I-SS, and wherein synchronization sources forwarding synchronization information derived from a synchronization source with a priority lower than the priority of the I-SS mute transmission of synchronization signals in response to receiving the second synchronization signal.

34. The UE of claim 31, wherein the I-SS comprises a peer UE that is outside network coverage.

35. The UE of claim 31, wherein the I-SS comprises a first synchronization source, and wherein the UE is further configured to determine a time resource associated with the UE that is different in time than a second synchronization source that is synchronized with the I-SS.

36. The UE of claim 35, wherein the UE is further configured to advertise the time resource associated with the UE.

37. The UE of claim 31, wherein the UE is further configured determine whether the UE is located near a boundary of a synchronization area based on one or more of a hop count and/or a received signal strength from the I-SS.

38. The UE of claim 37, wherein the UE is further configured to, in response to determining that the UE is located near the boundary, transmit data communications during time resources and within frequency resources less than an available frequency resource for transmission.

39. The UE of claim 38, wherein determining the time resource and synchronizing comprise determining the time resource and synchronizing in response to a signal strength of the first synchronization signal exceeding a predefined threshold value.

40. The UE of claim 31, wherein the I-SS comprises a first synchronization source, wherein the UE is further configured to:
receive a signal from the first synchronization source activating the UE as a gateway synchronization source (G-SS); and
transmit additional synchronization signals comprising timing based on the first synchronization signal from the first synchronization source.

41. A non-transitory computer readable storage medium that stores instructions for execution by one or more processors of a user equipment (UE), the instructions comprising:
a synchronization block to synchronize with an independent synchronization source (I-SS) based on a first synchronization signal received from the I-SS;
a detection block to determine whether a received signal strength from the I-SS is below a threshold value; and
an activation block to transmit a second synchronization signal propagating synchronization information derived from the I-SS to one or more peer UEs out of range of the I-SS, if the I-SS is below the threshold value,
wherein the second synchronization signal comprises a device-to-device synchronization signal (D2DSS).

42. The non-transitory computer readable storage medium of claim 41, wherein the I-SS comprises an Evolved Universal Terrestrial Radio Access Network (E-UTRAN) Node B (eNB), and wherein the one or more peer UEs are in partial network coverage.

43. The non-transitory computer readable storage medium of claim 41, wherein the second synchronization signal indicates a priority of the I-SS, and wherein synchronization sources forwarding synchronization information derived from a synchronization source with a priority lower than the priority of the I-SS mute transmission of synchronization signals in response to receiving the second synchronization signal.

44. The non-transitory computer readable storage medium of claim 41, wherein the I-SS comprises a peer UE that is outside network coverage.

45. The non-transitory computer readable storage medium of claim 41, wherein the I-SS comprises a first synchronization source, and wherein the instructions are further configured to determine a time resource associated with the UE that is different in time than a second synchronization source that is synchronized with the I-SS.

46. The non-transitory computer readable storage medium of claim 41, wherein the instructions are further configured to advertise the time resource associated with the UE.

47. The non-transitory computer readable storage medium of claim 41, wherein the instructions are further configured determine whether the UE is located near a boundary of a synchronization area based on one or more of a hop count and/or a received signal strength from the I-SS.

48. The non-transitory computer readable storage medium of claim 47, wherein the instructions are further configured to, in response to determining that the UE is located near the boundary, transmit data communications during time resources and within frequency resources less than an available frequency resource for transmission.

49. The non-transitory computer readable storage medium of claim 47, wherein determining the time resource and synchronizing comprise determining the time resource and synchronizing in response to a signal strength of the first synchronization signal exceeding a predefined threshold value.

50. The non-transitory computer readable storage medium of claim 41, wherein the I-SS comprises a first synchronization source, wherein the instructions are further configured to:
receive a signal from the first synchronization source activating the UE as a gateway synchronization source (G-SS); and
transmit additional synchronization signals comprising timing based on the first synchronization signal from the first synchronization source.
